(19) United States
(12) Patent Application Publication
(10) Pub. No.: US 2007/0017713 A1
(43) Pub. Date: Jan. 25, 2007

(54) Utility Track Machine With Undercarriage Bogie Rollers

(75) Inventors: Cody L. Sewell, Perry, OK (US); Kendall C. Young, Stillwater, OK (US); Vernon T. Stellman, Stillwater, OK (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(73) Assignee: The Charles Machine Works, Inc., Perry, OK (US)

(21) Appl. No.: 11/423,231

(22) Filed: Jun. 9, 2006

Related U.S. Application Data
(60) Provisional application No. 60/689,242, filed on Jun. 10, 2005.

(51) Int. Cl. B62D 55/00

(52) U.S. Cl. 180/9.1

(57) ABSTRACT

A tracked multifunction work machine and tool carrier having bogie rollers. The machine includes an upper frame supported on an undercarriage. The upper frame includes a tool adapter and an operator station. The tool adapter supports a variety of work tools that can be selected for various operations. The operator station provides platform so the machine can be operated while walking behind or standing on the platform. The undercarriage includes a plurality of tracks for propelling the machine along the ground. Each track is associated with pairs of bogie rollers that engage the tracks as the tracks traverse the ground. The pairs of bogie rollers are pivotally mounted on the undercarriage, providing additional support of the tracks with the ground.

### CROSS REFERENCE TO RELATED APPLICATION

This application claims the benefit of U.S. Provisional Application No. 60/689,242 filed Jun. 10, 2005, the contents of which are incorporated fully herein by reference.

### FIELD OF THE INVENTION

The present invention relates to apparatus and method for improving the ride characteristics of a compact, stand-on operated multipurpose work machine (also referred to as a multipurpose tool carrier), which utilizes a low-profile tracked undercarriage. More specifically, the present invention relates to the elements of the two endless tracks of the undercarriage that provide points of ground support to the compact stand-on operated machine. The end result is an improved “ride” for the stand-on operator in comparison to the conventional tracked undercarriages presently utilized on such compact multipurpose work machines.

### BRIEF DESCRIPTION OF THE DRAWINGS

FIG. 1 is a side view of a stand-on operated, multipurpose work machine (also referred to as a tool carrier) utilizing the low-profile undercarriage of the present invention.

FIG. 2 is a side view depicting the right track drive arrangement of the low-profile undercarriage of the present invention.

FIG. 3 shows the track drive of FIG. 2 negotiating a raised obstacle such as a rock or concrete curb.

FIG. 4 is an overhead sectional view of the track drive of FIG. 2.

FIG. 5 is a partially sectional view of a rubber track suitable for use on the track drives (FIGS. 2-4) of the stand-on operated, multipurpose work machine of FIG. 1.

FIG. 6 is a sequence of side views depicting a machine with conventional undercarriage passing over an obstacle.

FIG. 7 is a sequence of side views depicting a machine with an undercarriage of the present invention passing over an obstacle.

FIG. 8 is a side view depicting the right track drive arrangement of the low-profile undercarriage of an alternative embodiment of the present invention.

FIG. 9 shows the implements of the track drive of FIG. 8 negotiating a raised obstacle.

FIG. 10 is an overhead sectional view of the track drive of FIG. 8.

### DESCRIPTION

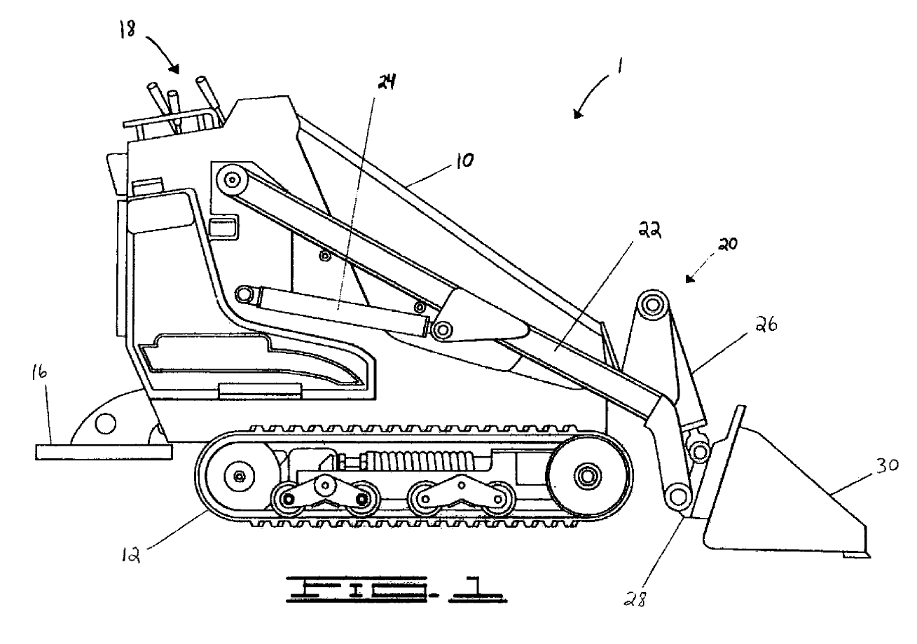

Turning to FIG. 1, shown in side view is a compact, stand-on operated multipurpose work machine (a.k.a., multipurpose tool carrier) 1. The stand-on operated machine 1 is comprised of a compartment 10 housing an engine and hydraulic pumps that supply power to a plurality of independently controlled track drives 12, of the machine-propelling undercarriage. The plurality of track drives 12 generally comprises a right track drive and a left track drive (not shown). An independent control 18 provides skid-steering for the stand-on operated machine 1. A platform 16 is provided at the rear of the machine 1 for a standing operator. The multipurpose machine 1 pivotally supports a tool carrier assembly 20 comprised of at least one lift arm 22 and at least one pivotal actuator such as a lift cylinder 24. A distal end of the lift arm(s) 22 may be equipped with one of a multitude of working tools 30, such as: a rotary broom, a variety of loader buckets, pallet forks, stump grinder, backfill blade, auger backfiller, posthole auger, vibratory plow, shrub spade, jackhammer, and other useful tools. Their interchange may be enhanced by utilizing a conventional quick-attach adapter 28 pivotally mounted to the lift arm(s) 22. The working tools 30 are held at or moved to one or more desired stowage and work positions by way of an orientation actuator such as a tilt cylinder 26. The actuators 24 and 26 and auxiliary powered work tools 30 are activated by appropriate operator controls 18.

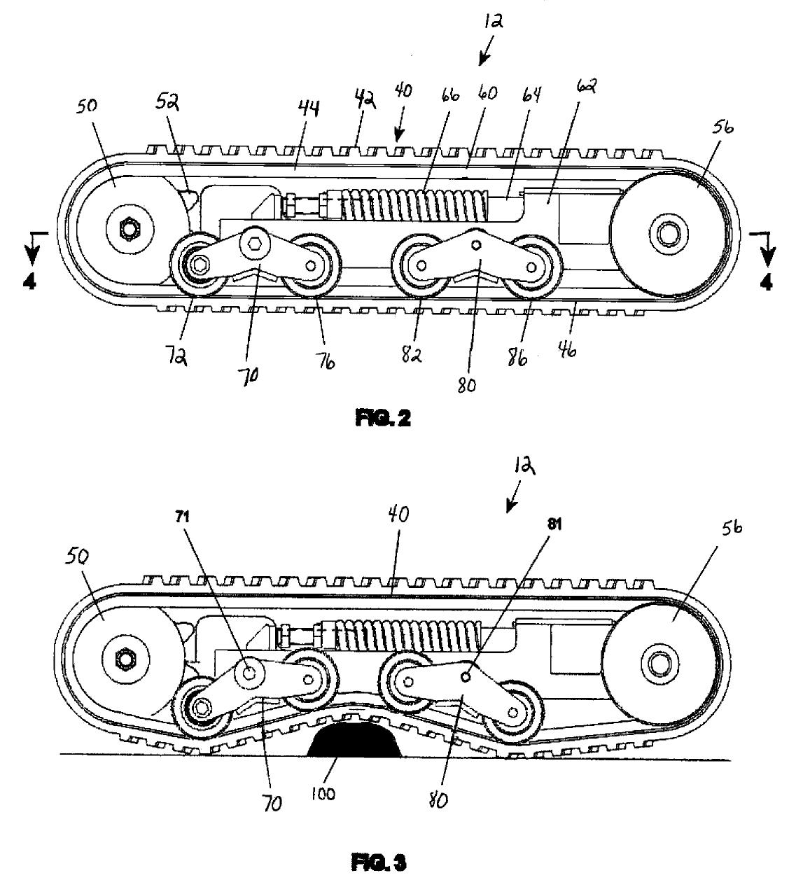

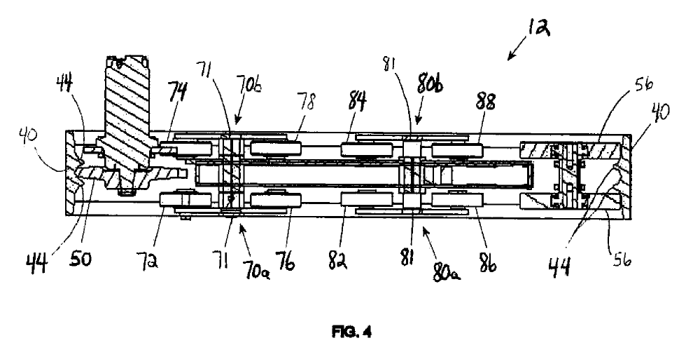

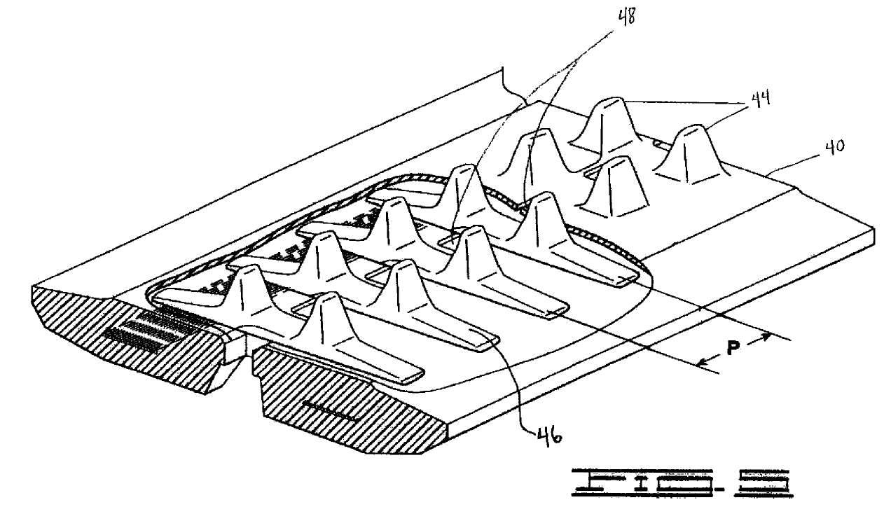

With reference now to FIG. 2 and its horizontal cross-section FIG. 4, shown therein is the right track drive 12 of the work machine 1. (The left track drive is a mirror image of the right, thus need not be separately described.) The track drive 12 comprises a track 40, although the track 40 could be otherwise formed (e.g., a segmented steel track), preferably it is a one-piece molded rubber track (as shown in FIG. 5). Such tracks 40 are commonly available with a selection of tread 42 types offering varying degrees of tractive capability (i.e., soil engaging aggressiveness). The endless track 40 is supported by (loops around) a drive sprocket 50 and a set of idlers 56. For simplicity of illustration, the tread 42 is not shown in the area where the track 40 loops around the drive sprocket 50 and the idlers 56. Although shown at the front end of the machine 1, the position of the idlers 56 could be interchanged with that of the drive sprocket 50. As best seen in FIG. 4, the front idlers 56 may comprise two outer rollers, of smooth circumference, laterally disposed about track guides 44 that are molded into the track 40, along its central interior. The drive sprocket 50 is centrally positioned with respect to the lateral width of the track 40, riding within the track guides 44. The teeth 52 of the drive sprocket 50 engage segmented drive lugs 46 (shown in FIG. 5, but not individually illustrated in FIGS. 1-4). The drive sprocket 50 and idlers 56 are supported by a track frame 62, which attaches to the main frame (not shown) of the work machine 1. A track tensioning arrangement 60 is comprised of the track frame 62, a take-up slide 64 and a compression spring 66. (The take-up slide 64 is also the supporting structure for the front idlers 56.) Such commonly known tensioning arrangements are utilized, for instance, to allow the track 40 to jettison debris that might enter the drive system. In the present invention, the tensioning arrangement 60 also allows the track 40 to vertically flex along its ground-engaging interface for improved traction and ride on uneven ground (FIG. 3).

With continued reference to FIG. 2, the track drive 12 comprises a plurality of bogies 70, 80 supported on the frame 62. In the preferred embodiment, the bogies 70, 80 are disposed on an inside and an outside of the frame 62. The bogies 70, 80 are preferably paired to comprise a set of front 80 (i.e., 80a and 80b) and rear 70 (i.e., 70a and 70b) bogies individually pivotally supported on the track frame 62. As best seen in FIG. 4, the inner 80b and outer 80a front bogies share a common pivot axis 81, while being supported thereon independently. Likewise, the inner 70b and outer 70a rear bogies are independently supported on their pivot axis 71. This allows the track 40 to flex laterally (interspatially twist between the drive sprocket 50 and the front idlers 56), to better maintain a ground-engaging interface across the width of the tread 42 while traversing uneven ground. Respective inner and outer bogies each have bearingly supported front and rear rollers. For instance, the outer rear bogie 70a has a rear roller 72 and a front roller 76. The various inner (74, 78, 84, and 88) and outer (72, 76, 82, and 86) rollers straddle the track guides 44, while being in approximate longitudinal alignment with the front idlers 56. By straddling the track guides 44, the rollers 72-78, 82-88 and the front idlers 56 work in combination to hold the track guides in alignment with the drive sprocket 50.

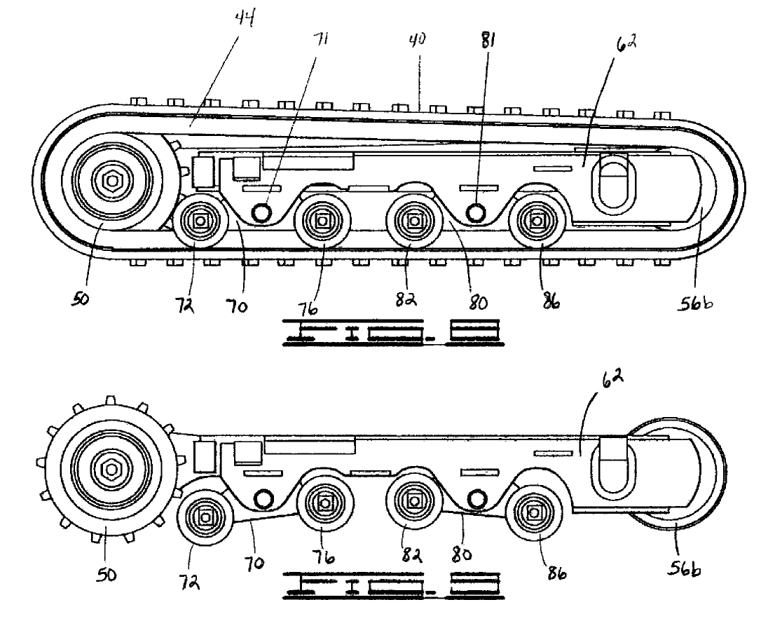

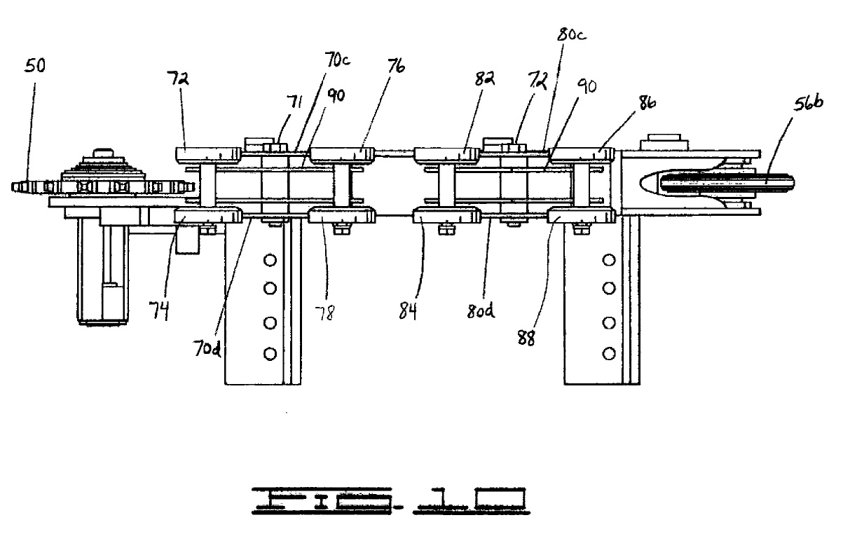

An alternative design of the drive track is shown in FIGS. 8-10. The endless track 40 is supported by the drive sprocket 50 and a single, center-mounted idler 56b. This provides less wear on the drive track than a set of front idlers. The drive sprocket 50 and idler 56b are supported by the track frame 62, which attaches to the main frame of the work machine 1. The track drive 12 comprises a set of front 80 and rear 70 bogies pivotally supported on the track frame 62. Each set of bogies 70, 80 comprises a common pivot axis 71, 81. With the alternative design, the inner 70d, 80d and outer 70c, 80c bogies are not independent of each other. Each set of bogies are mounted on a support frame 90, connecting the front inner 78, 88 and the front outer 76, 86 rollers together and connecting the rear inner 74, 84 and the rear outer 72, 82 rollers together. The single, center-mounted idler 56b and the alternative support frame 90 for the rollers offer a reduced cost in production while still maintaining a good ground-engaging surface and a smooth ride for the operator.

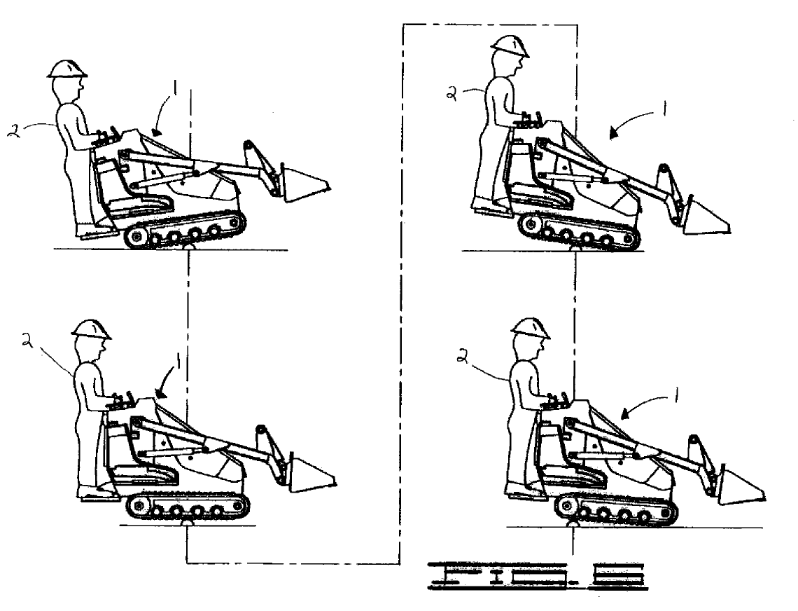

The bogies 70, 80 and drive sprocket 50 are purposefully positioned for improved operator ride; i.e., to reduce vibration created at the dynamic interface between the track drives 12 and the ground. This is accomplished by four aspects of their position and operation: (1) nominal vertical location of the drive sprocket 50 with respect to the bogie rollers 72-78, 82-88, (2) the spacing between adjacent bogie rollers 72-78, 82-88, (3) fore and aft positioning of the bogies 70, 80 with respect to the rear drive sprocket 50 and idlers 56, and by (4) an oscillation limit imposed upon the rear bogies 70. In the first instance, the drive sprocket 50 is vertically positioned such that its rolling circumference is above those of the bogie rollers 72-78, 82-88 and the front idlers 56. Thus, on a hard level surface, the bogie rollers 72-78, 82-88 and the front idlers 56 provide the ground support for the work machine 1. That is, the track 40 to ground interface is substantially limited to the interval between the rearmost rollers 72, 74 and the front idlers 56. Holding the drive sprocket 50 above ground contact eliminates or at least “feathers out” any ground contact impulse the teeth 52 of the sprocket 50 could otherwise interject as a vertical impulse at the rear end of the machine 1 each time one of them passes below the center of rotation of sprocket 50. (With the drive sprocket 50 being almost directly under the operator 2 such an impulse can be bone-jarring for a conventional tracked undercarriage—see FIG. 6.) The proper amount by which the track 40 contacting points of the bogie rollers 72-78, 82-88 and the front idlers 56 are vertically positioned (offset) below those of the drive sprocket 50 depends upon a number of parameters, including: the overall length of the track drives 12, the weight of the machine 1, the diameters of the drive sprocket 50 and the front idlers 56, and the tread 42 style of the track 40. For a compact stand-on operated multipurpose work machine 1, the vertical offset necessary to obtain the above-described benefits may be in the range of 0.2 to 1.0 inches. More preferably the offset is in the range of 0.2 to 0.5 inches. Given the goal of improved operator ride, one skilled in the art can make the necessary tradeoff decisions during an undercarriage design to determine the proper amount of vertical offset to be instituted. For some applications where the stand-on operated machine 1 is working almost exclusively on hard surfaces such as pavement, it may also be beneficial to raise the front idlers 56 a similar amount above the bogie rollers 72-78, 82-88. This “feathers out” the ground contact impulse of the tread 42 that would normally occur below the center of rotation of the front idlers.

Secondly, when defining the intervals between the contact points of adjacent sets of rollers (72, 74) to (76, 78); (76, 78) to (82, 84); and (82, 84) to (86, 88) and between rollers 86, 88 and the front idlers 56, an important aspect is that these intervals preferably be equal to an odd multiple (1, 3, 5, etc.) of approximately one-half the drive tooth 52 spacing. The drive tooth 52 spacing is also the pitch P of the rubber track, as illustrated in FIG. 5. The track guides 44 are comprised of embedded metal segments 46 spaced a distance P apart. A plurality of tooth grips 48 are disposed between the guides 44, also at a distance apart, to accept the drive teeth 52 there between and transfer the rotational torque from the drive sprocket 50 into the rubber track 40. The embedded metal segments 46 extend laterally across the track 40 such that the bogie rollers 72-78, 82-88 and the front idlers 56 roll over their extended flanges. The above purposeful interval spacing between the bogie rollers 72-78, 82-88 prevents all of them from rolling over embedded metal segments 46 simultaneously. This time-distributes the rolling contacts and reduces their potential jarring effect on the operator. One skilled in the art can appreciate that a lesser differential between the roller spacing and the pitch P of the track guides 44 than described above may provide noticeable benefit as well.

In the third aspect, bogie positioning, the rear bogies 70 are positioned substantially closer to the drive sprocket 50 of the track drive 12 than are the front bogies 80 with respect to the front idlers 56. As best seen in FIG. 2, the unsupported interval of track 40 between the drive sprocket 50 and the rear rollers 72, 74 of the rear bogies 70 is of length approximately equal to one diameter of the rollers 72, 74. (Preferably this interval is less than 1½ diameters long.) Whereas, other unsupported track intervals between the contact points of adjacent sets of rollers—i.e.: (72, 74) to (76, 78); (76, 78) to (82, 84); and (82, 84) to (86, 88)—and between rollers 86, 88 and the front idlers 56 may be as much as two to four times longer. Preferably these intervals are less than 3 diameters long and, although not required, may be approximately evenly spaced—so long as the previous consideration of roller spacing in relation to pitch P is also met. Purposeful close positioning of the rear bogies 70 improves their ability to hold the teeth 52 of the drive sprocket 50 from impinging the ground surface. That ability is further augmented by the oscillation limit imposed upon the rear bogies 70.

This—the fourth aspect—is best explained by referring to FIG. 3 in conjunction with FIG. 2. The pivot-mounted bogies 70, 80 have a range of oscillatory motion to aid in traversing over rocks or other obstacles 100 protruding above the ground surface. The front bogies 80 are configured to have substantially the same clockwise (CW) and counterclockwise (CCW) oscillation limits—as displaced from the level or neutral position shown in FIG. 2. Although not limiting upon the present invention, the oscillation limits may be on the order of 15 degrees either side (i.e., CW and CCW) of the neutral position. The rear bogies 70 may have approximately the same CCW oscillation capability; however, they are prevented from having full CW displacement away from their FIG. 2 illustrated neutral position by stops. For instance, their CW displacement may be limited to less than one-third of their CCW displacement. Preferably the stops are more limiting, to the point of permitting no CW displacement of the rear bogies. The benefit of this feature is that fewer teeth 52 of the drive sprocket 50 are able to contact the obstacle 100 when the rear of the track drive 12 passes over it. This is best explained by considering the various stages involved when the stand-on operated compact work machine 1 encounters an obstacle 100.

Prior art machines with conventional undercarriage of fixed-position rollers would climb over the obstacle 100 in a “teeter-totter” fashion, as shown in the sequential views of FIG. 6. The front idlers 56 continue to rise after they cross the obstacle (View A), until the machine reaches a balance point directly over the obstacle (View B). Then the machine tilts forward (View C) to rapidly drop the front idlers 56 back to the ground. Finally (View D), the drive sprocket 50 passes over and drops off the obstacle 100. This teeter-totter motion can impart substantial upward and downward acceleration into the standing operator 2.

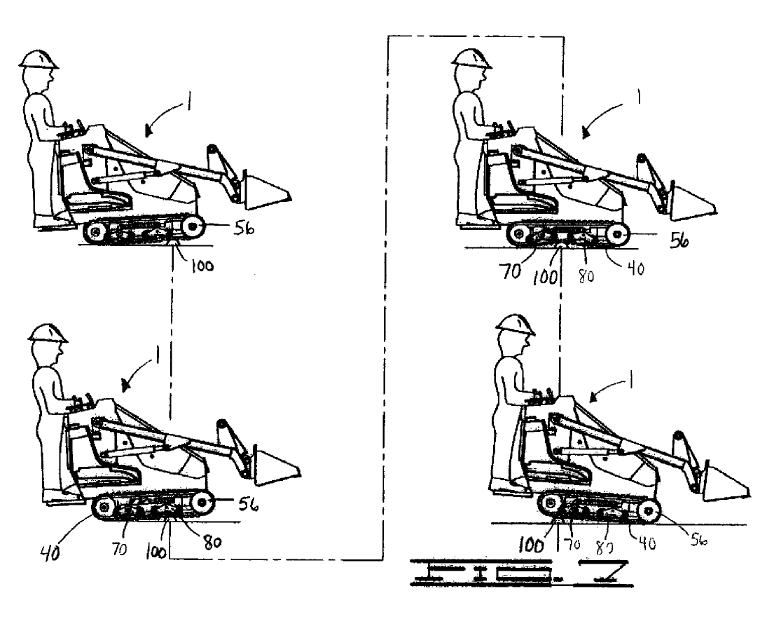

The present invention is the application of a novel track suspension on small stand-on operated multipurpose work machines 1. Until now, machines of this nature have not been equipped with such undercarriages. The sequence of passing over an obstacle 100 is shown in FIG. 7. The obstacle 100 is first engaged by the tread 42 wrapping around the front idlers 56. Assuming the tread 42 does not slip on the obstacle 100, continued rotation of the drive sprocket causes the idlers 56 to raise and “walk” onto, then over the obstacle (View A). In the meantime, the front bogies 80 begin to oscillate CCW about their pivot axis 81. This softens the lowering of the front idlers 56 (slows the rate at which they fall back toward the ground). The track suspension also prevents them from being lifted so high above the ground (compare FIG. 6 View A to FIG. 7 Views A and B). The concentrated reactionary load of the obstacle 100 on the unsupported span of track 40 between the front idlers 56 and the front rollers 86, 88 of the front bogies 80 may also increase the track tension sufficiently to move the front idlers 56 and take-up slide 64 rearward, further compressing the spring 66. (In the FIG. 7 sequences, the take-up slide 64 will move back and forth in response to changing track tension brought about by the respective position of the obstacle along the track to ground interface.) For a machine 1 of approximately balanced fore and aft center of gravity location, the idlers 56 will again be lifted when the front bogies 80 pass directly over the obstacle 100 (View B). The front bogies 80 rotate CW back toward their neutral position and then continue that rotation as dictated by the size and shape of the obstacle 100, or until their CW oscillation limits are reached. During this time, the front idlers 56 lower and the rear bogies 70 begin to rotate CCW about their pivot axis 71. The rear bogies 70 will continue that rotation as dictated by the size and shape of the obstacle 100, or until their CCW oscillation limits are reached (View C). The obstacle 100 is now in the same location as depicted in FIG. 3. When the rear bogies 80 pass directly over the obstacle 100, the drive sprocket 50—because of its close proximity—raises to approximately the same level. The rear bogies 70 have rotated CW back toward their neutral position. However as the machine 1 continues forward, the rear bogies 70 are purposefully prevented by stops from rotating clockwise beyond their neutral position (View D). The obstacle 100 is thereby prevented from causing more than incidental deflection of the short track 40 interval between the rear rollers 72, 74 and the drive sprocket 50. Essentially only those teeth 52 of the drive sprocket 50 fitting within an angle of departure of the obstacle 100 have the potential for creating contact with it. Thus, as stated earlier, the present invention limits the number of teeth 52 able to contact the obstacle 100 when the rear of the track drive 12 passes over it—thereby also limiting the number of machine jarring tooth impulses associated with such contact. The result is a smoother ride for the stand-on operator.

The present invention not only reduces the “pitching” acceleration going over large obstacles (as described above), it also makes higher speed operation smoother for the operator and improves stability on side slopes. With respect to side slope operation, the obstacle negotiating sequences described above clearly show that there will be less “lifting” of the up slope track drive 12 of the present invention when it encounters an obstacle 100 than would be the case for a conventional (FIG. 6) undercarriage. Other benefits of the present invention include improved track 40 life and less turf damage, especially on moderately firm surfaces, due to improve load distribution and less scuffing at the ends of the track drives 12.

Although the above benefits have been described in relation to a compact, stand-on operated multipurpose work machine, this bogie undercarriage configuration is also suitable for larger, ride-on operated work machines. Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

1. A tool carrier machine comprising:
a drive frame undercarriage having a plurality of track drives;
an upper frame supported on the undercarriage;
a tool adaptor attachable to the upper frame and adapted to support a work tool; and
an operator station supported on the upper frame, the operator station adapted to allow operation of the machine while walking behind or standing on the machine;
wherein the plurality of track drives each comprise a track and at least one set of pivotable rollers positioned to engage the track as the track contacts a ground surface.

2. A stand-up ride-on operated tool carrier machine comprising:
a frame;
an undercarriage attached to the frame and having a plurality of track drives;
a tool adaptor movably attached to the frame and adapted to support a work tool; and
an operator station supported on the frame, the operator station comprising a platform and adapted to allow operation of the machine while standing on the platform;
wherein the plurality of track drives each comprise a track and at least one set of bogie rollers positioned to engage the track as the track contacts a ground surface.
